(19) United States
(12) Patent Application Publication
(10) Pub. No.: US 2020/0209025 A1
(43) Pub. Date: Jul. 2, 2020

(54) ULTRASONIC FLOWMETER

(71) Applicant: Bermad CS Ltd., Kibbutz Evron (IL)

(72) Inventor: Dan Winter, Tel Aviv-Yafo (IL)

(21) Appl. No.: 16/236,536

(22) Filed: Dec. 30, 2018

(51) Int. Cl. G01F 1/66; G01F 15/06

(52) U.S. Cl. CPC G01F 1/662; G01F 15/063

(57) ABSTRACT

A flowmeter integrated with a controller that generates control signals for system components, such as valves, based in part on the fluid volume measurement. Additionally, or alternatively, where an ultrasonic flowmeter is used, it includes an embedded non-volatile memory chip which is a fixed part of the flowmeter mechanical structure, and which interfaces with replaceable electronic components to provide calibration data for the flow characteristics of the mechanical structure. Additionally, or alternatively, a digital flowmeter may provide a trickle-flow indication to help identify slow leakage conditions which are otherwise difficult to detect from a digital flowmeter display.

### FIELD OF THE INVENTION

The present invention is directed to flowmeters.

### BACKGROUND OF THE INVENTION

In many developed countries, flowmeters are used to measure the volume of water used by residential and commercial buildings that are supplied with water by a public water supply system, and for other applications in agriculture and in industry. Flowmeters can also be used at a water source or throughout a water system to determine flow through a particular portion of the system, either for billing purposes of as part of a metering/control system. There are several types of flowmeters: positive displacement flowmeters, velocity meters, mechanical or electronic types such as electromagnetic meters, and ultrasonic meters.

An ultrasonic flowmeter is a type of flowmeter that measures the velocity of a fluid using ultrasound to calculate the volumetric flow. Using ultrasonic transducers, the flowmeter can measure the average velocity along the path of an emitted beam of ultrasound, by calculating the difference in transit time between the pulses of ultrasound propagating with and against the direction of the flow or, in some cases, by measuring the frequency shift of signals reflected from particles within the flow from the Doppler Effect.

Sometimes water meters are used in conjunction with other components to form a system. Conventional water systems that employ ultrasonic flowmeters in wired connection to other system components are prone to various hazards, such as weather damages, rodents' damages, wear damages and the like, due to the physical connection between the flowmeters and other elements of the system. Furthermore, replacing elements of conventional water systems requires recalibration of the flowmeter each time.

### SUMMARY OF THE INVENTION

The present invention provides a flowmeter for measuring the volume of a fluid passing through a flow path, in some cases combined with control components for controlling a system.

Thus, according to an embodiment of the present invention there is provided an apparatus integrating a flowmeter and a controller for a system including at least one wirelessly controllable flow-control device, the apparatus comprising: a body defining a fluid flow path from an inlet to an outlet; a fluid flow sensor mechanically associated with the body and configured to generate a signal sufficient to allow derivation of a rate of fluid flow along the flow path; a wireless communications interface mechanically associated with the body and configured for communicating with the at least one wirelessly controllable flow-control device; and a processing system, mechanically associated with the body, comprising at least one processor and a data storage device, the processing system being in communication with the sensor and the wireless communications interface, the processing system being configured to: derive from the signal a volume of the fluid passing along the flow path; and, generate control signals to be transmitted by the wireless communications interface for actuation of the at least one wirelessly controllable flow-control device according to a program.

According to a further feature of an embodiment of the present invention, the fluid flow sensor comprises an ultrasonic transducer configured to transmit an ultrasonic signal into fluid within the flow path; and an ultrasonic transducer configured for receiving the ultrasonic signal after passing through the fluid.

According to a further feature of an embodiment of the present invention, there is also provided: at least one electrically controlled valve controlling flow along a flow path supplied via the flowmeter; at least one additional device selected from the group consisting of: a sensor, a pump and a greenhouse environment controller; and wireless communications components providing wireless communication between the electrically controlled valve, the at least one additional device and the controller.

According to a further feature of an embodiment of the present invention, the wireless communications interface uses a form of communication selected from the group consisting of: Bluetooth communication, GPRS communication, cellular communication and the combination thereof.

According to a further feature of an embodiment of the present invention, the program is defined in part by at least one volume of fluid to be delivered as derived by the processing system.

There is also provided according to the teachings of an embodiment of the present invention, a flowmeter comprising: a body defining a fluid flow path from an inlet to an outlet; a fluid flow sensor configured to generate a signal indicative of a rate of fluid flow along the flow path, the fluid flow sensor comprising: an ultrasonic transducer configured to transmit an ultrasonic signal into fluid within the flow path, and an ultrasonic transducer configured for receiving the ultrasonic signal after passing through the fluid; and a processing system comprising at least one processor and a data storage device, the processing system being in communication with the sensor, the processing system being configured to: derive from the signal a flow rate of the fluid passing along the flow path; when the flow rate exceeds a threshold flow value, to integrate the flow rate to determine a volume of the fluid that has passed along the flow path; and, at least when the flow rate is below the threshold flow value, to generate an output indicative of a detected fluid flow along the fluid flow path.

According to a further feature of an embodiment of the present invention, there is also provided a graphic display screen associated with the body and in communication with the processing system, wherein the output is generated as a visual indication on the graphic display screen of the detected fluid flow.

According to a further feature of an embodiment of the present invention, the output is generated as an alert transmitted to a remote location.

According to a further feature of an embodiment of the present invention, the processing system is in communication with a wireless controller.

According to a further feature of an embodiment of the present invention, the processing system is further configured to identify at least one condition selected from the group consisting of: a faulty flow-control device, a leak, a blockage, and presence of air bubbles.

There is also provided according to the teachings of an embodiment of the present invention, a flowmeter comprising: a body defining a fluid flow path from an inlet to an outlet; a fluid flow sensor configured to generate a signal indicative of a rate of fluid flow along the flow path, the fluid flow sensor comprising: an ultrasonic transducer configured to transmit an ultrasonic signal into fluid within the flow path, and an ultrasonic transducer configured for receiving the ultrasonic signal after passing through the fluid; a non-volatile memory chip permanently mechanically integrated with the body, the non-volatile memory chip storing calibration data for the flowmeter; and a processing system comprising at least one processor and a data storage device, the processing system being in communication with the sensor and the non-volatile memory chip, the processing system being configured to: read from the non-volatile memory chip the calibration data; and derive from the signal and the calibration data a volume of the fluid passing along the flow path.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a schematic block diagram of an apparatus integrating a flowmeter and a controller for measuring the volume of a fluid passing through a flow path, constructed and operative according to an embodiment of the present invention.

FIG. 2A-E are isometric views of an implementation of the apparatus of FIG. 1 with various components sequentially removed to reveal internal components.

FIG. 3 is an enlarged isometric cut-away view of a recess within a body of the apparatus of FIG. 2A in which a non-volatile memory chip is located.

FIG. 4 is an isometric view of the apparatus of FIG. 2A cut-away on a horizontal plane.

FIG. 5 is a schematic illustration of the apparatus integrated as part of an irrigation system.

FIGS. 6A-6D are successive states of a display panel of the apparatus of FIG. 2A according to a further aspect of the present invention for displaying trickle-flow conditions.

### DESCRIPTION OF THE PREFERRED EMBODIMENTS

The present invention is an apparatus including a flowmeter for measuring the volume of a fluid passing through a flow path, and which, according to a first aspect of the invention, integrates such a flowmeter with a controller that generates control signals for actuation of components in communication with the apparatus based on the fluid volume measurement and/or elapsed time. According to a further aspect of the present invention, an ultrasonic flowmeter is provided with an embedded non-volatile memory chip which is a fixed part of the flowmeter mechanical structure, and which interfaces with replaceable electronic components to provide calibration data for the flow characteristics of the particular mechanical structure, each of which has its own individual flow properties, due to manufacturing tolerances and variations in the flow channel. These two aspects may be used independently, or can be used to particular advantage synergistically in a single system, as will be exemplified herein below.

Although the invention will be exemplified throughout the description by reference to a flowmeter, it should be noted that the teachings of the invention are not inherently limited to the context of systems conveying only water, and the invention can equally be used to advantage in various systems which deliver or otherwise control the flow of a range of liquids including but not limited to, potable water, recycled water and other irrigation-grade water, waste water, seawater, other water-based solutions, and various non-aqueous liquids such as petroleum derivative products.

The principles and operation of the apparatus according to the present invention may be better understood with reference to the drawings and the accompanying description.

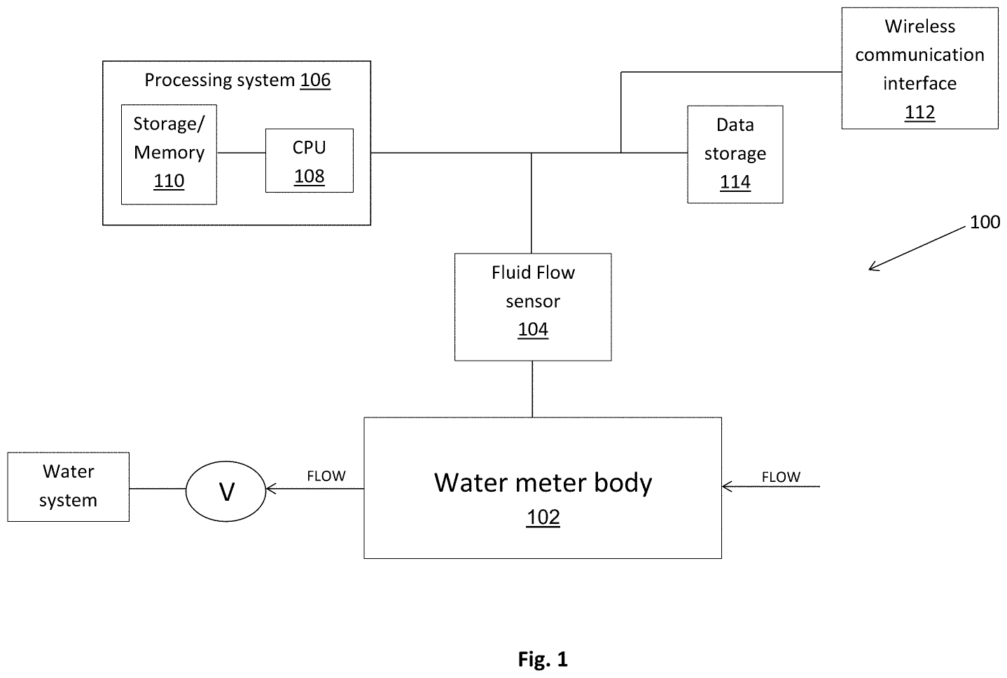

FIG. 1 is a schematic diagram of apparatus 100. The apparatus 100 includes a body 102 defining a fluid flow path that extends from an inlet to an outlet. The inlet and outlet are connected to pipes or tubes that define a flow path of water through the body 102. The apparatus 100 includes a fluid flow sensor 104 configured to generate a signal indicative of a rate of fluid flow along the flow path. In particularly preferred implementations, sensor 104 contains an ultrasonic transducer configured to transmit an ultrasonic signal into the fluid within the flow path, and an ultrasonic transducer configured for receiving the ultrasonic signal after passing through the fluid. The fluid flow sensor 104 is in communication with a processing system 106 that includes: a Central Processing Unit (CPU) 108 and a storage/memory 110. The CPU 108 is formed of one or more processors, typically microprocessors, which may be dedicated hardware or any combination of generic hardware with suitable software, as well as any combinations thereof, acting under the control of any suitable operating system and executing instructions defined by suitable software. The storage/memory 110 is any conventional storage media, which may include any combination of volatile and non-volatile storage devices or any suitable type. The storage/memory 110 typically stores machine-executable instructions for execution by the CPU 108, to perform the processes of the invention. Alternatively, or additionally, the processor(s) may include one or more fully- or partially-customized processor, such as an ASIC, as is known in the art. The processing system 106 may include two sets of functions, and our preferred embodiment has both performed by the processing system: (1) operating the ultrasound flowmeter to actuate the components and deriving the flow rate; and (2) performing one or more control function based on logic conditions and/or algorithms employing the water flow measurements as input data.

According to certain particularly preferred implementations, the processing system 106 is in communication with a wireless communications interface 112. The wireless communications interface 112 is, according to certain preferred but non-limiting implementations, mechanically associated with body 102 and is configured for communicating wirelessly with other controllable components, typically including at least one flow-control device, such as a valve or, in some cases, an additive delivery pump for adding fertilizer and/or other additives to the water supply. The communication can be formed using different forms of communication, close and long, for example, Bluetooth communication, GPRS communication, cellular communication, cloud-based monitoring and the like. The processing system 108 derives the volume of the fluid passing along the flow path from the signal generated by the fluid flow sensor 104 and then generates control signals to be transmitted by the wireless communications interface 106 for actuation of, or other communication with, components that are in communication with it, such as temperature sensors, air humidity sensors, soil moisture sensors, volume sensors, drippers, sprinklers, valves, water systems, greenhouse environment controllers such as automatic blinds or fans, etc. The actuation of these components can also be carried out using a schedule stored in a data storage device 114 that is configured for storing executable instructions, such as operation schedules and the like. In some preferred cases, the schedule or program may use the measured water flow as a parameter in an algorithm for determining how to operate the flow-control device(s).

A further aspect of the present invention addresses a shortcoming which is common to a range of different digital flowmeters, particularly including but not limited to an ultrasonic flowmeter such as the example illustrated in the accompanying drawings, or a magnetic flowmeter. Ultrasonic and magnetic flowmeters do not require a flow-obstructing mechanism to be deployed in the flow path, and therefore benefit from low pressure losses and are suitable for high flow rates. On the other hand, ultrasonic and magnetic flowmeters have limited accuracy for very low flow rates, and are typically certified (i.e., considered reliably accurate) only down to a “threshold flow” lower flow rate limit. Flow rates below that threshold flow are not accurately measured, and are generally not recorded.

Because of this disregard for below-threshold flow rates, it can be difficult to identify certain fault conditions, such as when there is a slow flow via a faulty valve or a slow leak from a piping system. Digital flowmeters such as the aforementioned ultrasonic flowmeters disregard such low flow rates. It may therefore be impossible to detect a fault which gives rise to a below-threshold flow rate.

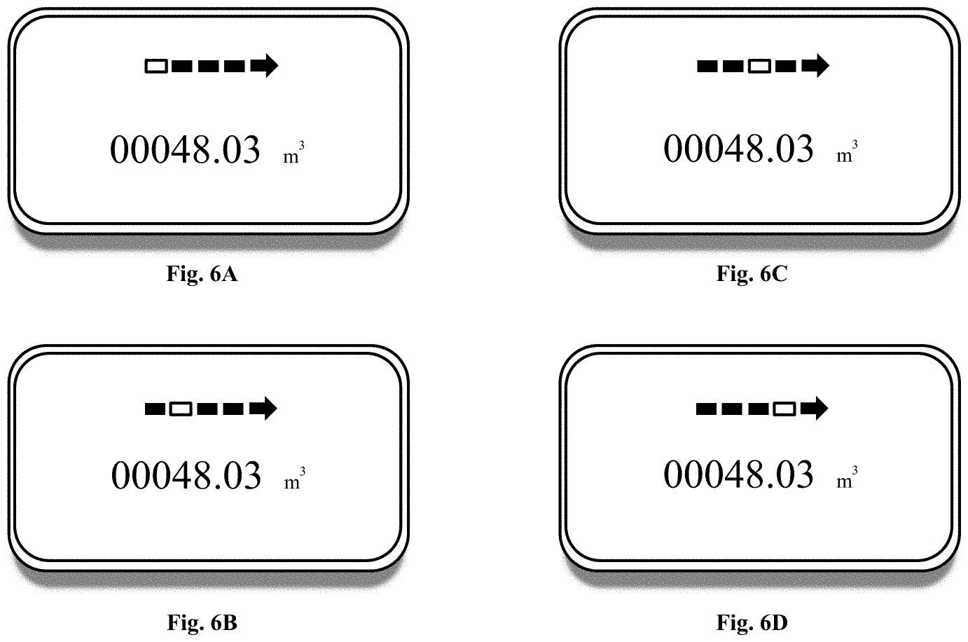

According to a further aspect of the present invention, the processing system actuates the display of the flowmeter device to generate an indication of water flow, and preferably also the flow direction, either continuously under all flow conditions or under predefined flow conditions, particularly below-threshold flow rates. Although such slow flow rates are not reliably measured in quantitative terms for metering purposes, a flow sensor such as the ultrasonic flow sensor described herein or a magnetic flow sensor can reliably distinguish between zero flow conditions and sub-threshold flow rates down to an order of magnitude or more below the threshold flow rate. Most preferably, the indication of water flow is a time-varying indication, such as a moving arrow, or a flashing arrow, or a symbol in which all or part of the symbol appears and disappears to give an impression of motion. One such example is illustrated in FIGS. 6A-6D, which show a number of successive states of a time-varying display, according to which successive segments of an arrow indication blink or flash, thereby indicating that the display is active to show that there is a current a flow of water in the direction of the arrow. The display thus serves as a trickle flow indicator, facilitating identification of any low-flow conditions which may be indicative of a malfunction of some valve or other system component, or of a leak in some part of the piping system. Additionally, or alternatively, low flow-rate conditions, or other suspicious flow-rate profiles that are indicative of a likely malfunction, may trigger transmission of an alarm signal, by wired or wireless communications, to a remote location in order to alert a remote operator, or an automated or semi-automated maintenance system, to investigate the cause of the suspicious flow-rate conditions.

In addition to the display of trickle-flow conditions, the water flow measurement data is preferably used by the processing system with various different logic algorithms to identify various error conditions that may interfere with the operation of the apparatus 100 and/or require user intervention. By way of example, the system may identify faulty valves by the failure of flow rates to change as and when expected in response to a valve operation instruction, may identify leaks by small residual flow rates under what should be zero flow conditions of the system, and can identify blockages by the system reaching lower-than-expected peak flow when a given valve is opened. Each of these error detection features is believed to be of value in its own right.

An additional, or alternative, feature that may be provided particularly in the case of an ultrasonic flowmeter is detection of the presence of air bubbles in the flow path. Air bubbles can be detected by abrupt changes in the ultrasound transmission properties between the transducers. In such cases, the processing system preferably adjusts the valve opening times to compensate for the period that air bubbles were passing through the flowmeter, so as to ensure that a desired quantity of water is actually delivered to the appropriate outlets.

The apparatus 100 can be operated using various energy sources, such as batteries, solar panels or an AC source, alone or any combination of power sources. The apparatus 100 may include a graphic display screen associated with body 102. The graphic screen is in communication with processing system 106, which activates the screen to display a visual identification of the flowmeter output, including the cumulative water flow data, and preferably also any trickle-flow condition of fluid flow along the fluid flow path, as described above. Where the device also operates as a controller for a water flow management system, as described herein, the display may advantageously be subdivided into two regions, or a second distinct display panel may be provided, which provides status information about the water flow management system operation and/or provides part of a user interface to allow adjustment of settings for operation of the water flow management system.

Since the electronic components of the flowmeter are more prone to damage, both by natural causes and through mechanical damage, than the main body of the flowmeter, it is desirable that it should be possible to replace some or all of the electronic components with minimum disruption to the flowmeter's operation. In order to allow prompt return to operation of the flowmeter with minimum disruption, according to an aspect of the present invention, a calibration data storage component that stores the calibration data of the flowmeter in such a way that it will be protected from environmental or mechanical damage, and allows quick and efficient replacement of damaged electronic components, without having to remove the flowmeter from the pipeline for calibration at a certified laboratory.

According to a further aspect of the present invention, which may be used to advantage in an otherwise conventional flowmeter, but is particularly valuable when used in synergy with the other features of apparatus 100 described herein, the apparatus 100 includes a non-volatile memory chip permanently mechanically integrated with body 102. The chip stores calibration data for apparatus 100 and is in communication with processing system 106 (which may be the dual-purpose flowmeter and controller processing system described above, or a conventional flowmeter processing system, according to the application). The processing system 106 reads the calibration data from the chip and derives a volume of the fluid passing through the flow path by combining the data with the signal from the fluid flow sensor 104. The chip is integrated with the metal structure of the body 102, preferably within a recess in the body filled with a waterproof filling compound so as to permanently fix the chip, typically with an electrical connector projecting from the recess.

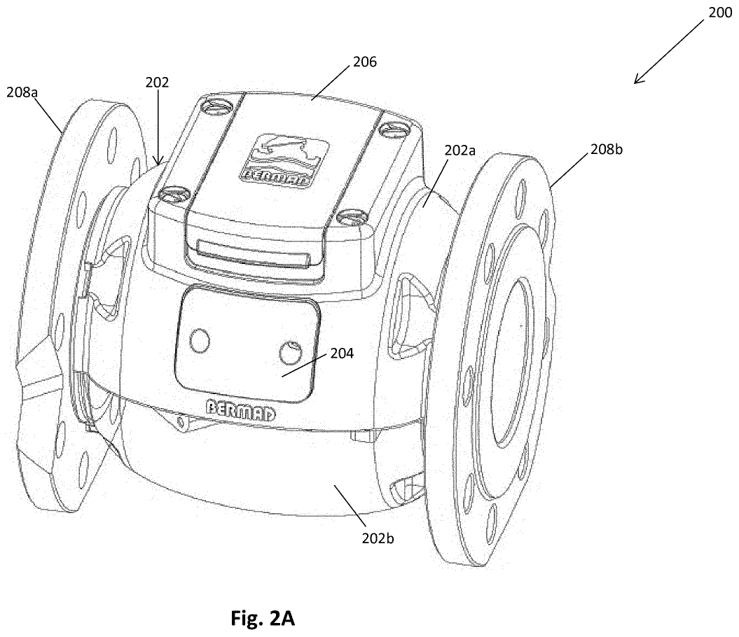

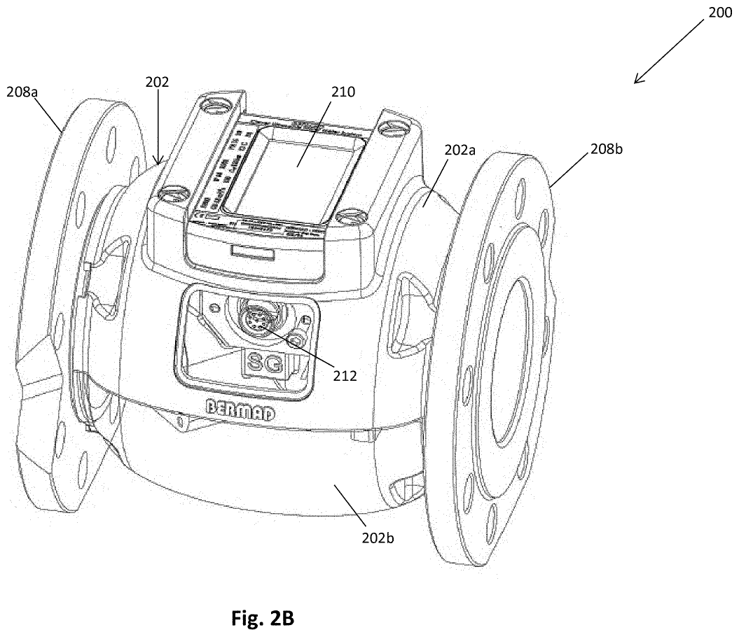

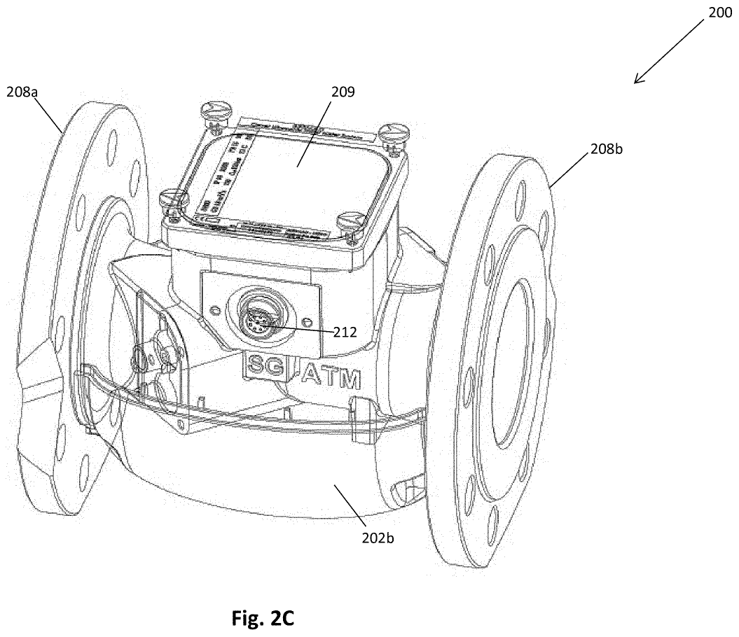

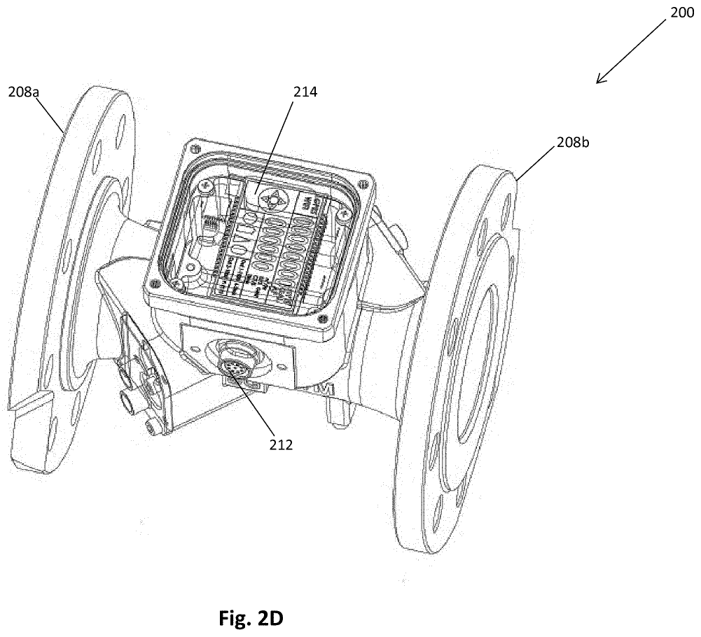

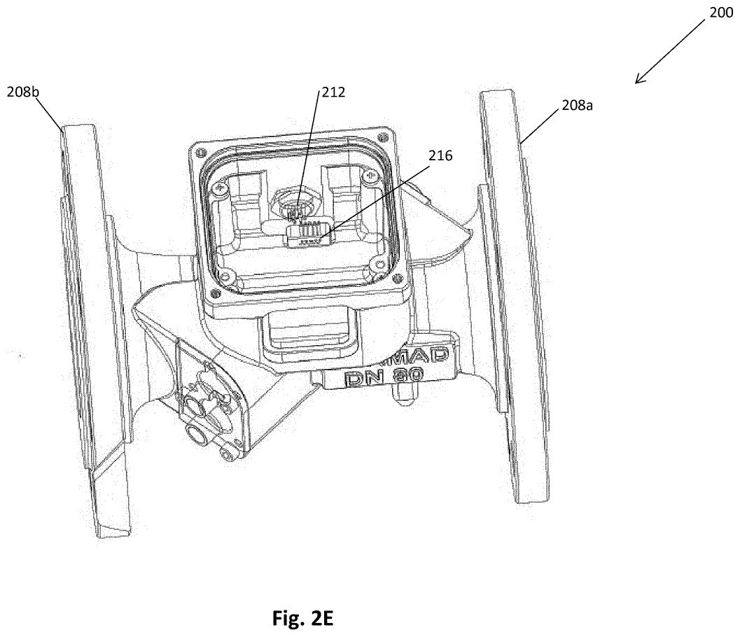

FIG. 2A-D represent isometric views of an exemplary, non-limiting implementation of apparatus 100, here designated 200, with various components sequentially removed to reveal internal components. FIG. 2A is an isometric view of apparatus 200. Apparatus 200 includes a body 202 formed of two polymeric shells 202a, 202b, fit together by a mechanical fit, e.g., snap (friction) fit, welds, bolts, or combinations thereof, or a chemical fit, e.g., adhesives, or combinations thereof. The shells 202a, 202b, when fitted together form a casing which defines a hollow cavity to house electronics and other operational components for the apparatus 200. Apparatus 200 includes a module unit cover 204 and a top cover 206. Provision of a two-part casing, effectively surrounding the central body of the fluid meter, offers a number of advantages, primarily in that it offers enhanced storage volume both above and below the body, thereby reducing the overall apparent bulk of the flowmeter compared to an equivalent apparatus with all the electrical components mounted at the top. Additionally, the storage volume in the lower part of the casing is particularly suited to housing components, such as batteries, which are sensitive to overheating or damage through over exposure to sunlight and solar heating, as it is largely sheltered and shaded by the metal body of the device. Apparatus 200 also includes two rounded flanges 208a and 208b on both sides of body 202 for connection in-line with a fluid flow piping system. Clearly, the form of the connection may be varied according to the dimensions, pipe diameters and accepted connectivity configurations for each particular application.

FIG. 2B is an isometric view of apparatus 200 where the module unit cover 204 and the top cover 206 have been removed. The removal of top cover 206 exposes a glass window 210 that protects the graphic display screen as well as other electronics and operational components of apparatus 200, while the removal of the module unit cover 204 exposes an electric connector socket 212, which may be used to connect the electronics system by wired connection for communication with a nearby computer or dedicated external controller, which may be used to set a schedule for controlling all components of the system and/or to read flowmetering data or any other current or historical data relating to system operation. FIG. 2C is a further isometric view of apparatus 200 where the upper polymeric shell 202a and the glass window 210 have been removed exposing the graphic display screen 209. FIG. 2D is yet another further isometric view of apparatus 200 where the lower shell 202b and graphic display screen 209 have been removed. The removal of graphic display screen 209 exposes the electronics and operational components of apparatus 200. Apparatus 200 includes a circuit board 214. The circuit board 214 includes the processing system and wireless communications interface of apparatus 200. The processing system can be in communication with a wireless controller, such as a smartphone, a tablet computer, a local PC and the like, allowing the external device to control the processing system remotely. FIG. 2E is yet another further isometric view of apparatus 200 where the circuit board 214 has been removed. The removal of circuit board 214 exposes a non-volatile memory chip 216 that is in communication with circuit board 214. The non-volatile memory chip 216 in positioned in a recess within the metal structure of body 202.

FIG. 3 is an enlarged isometric cut-away view of a recess within a body of the apparatus 200 of FIG. 2A in which a non-volatile memory chip 216 is located. The memory chip 216 is connected to circuit board 214 using a connector 218, which connects the non-volatile memory chip 216 and the circuit board 214 both mechanically and electrically. When there is a need to replace the circuit board and a new circuit board is introduced, calibration data and other information regarding apparatus 200 are transferred from the non-volatile memory chip 216 to the new control panel. This allows apparatus 200 to be returned promptly to operation after replacement of electronic components without requiring recalibration of the flowmeter.

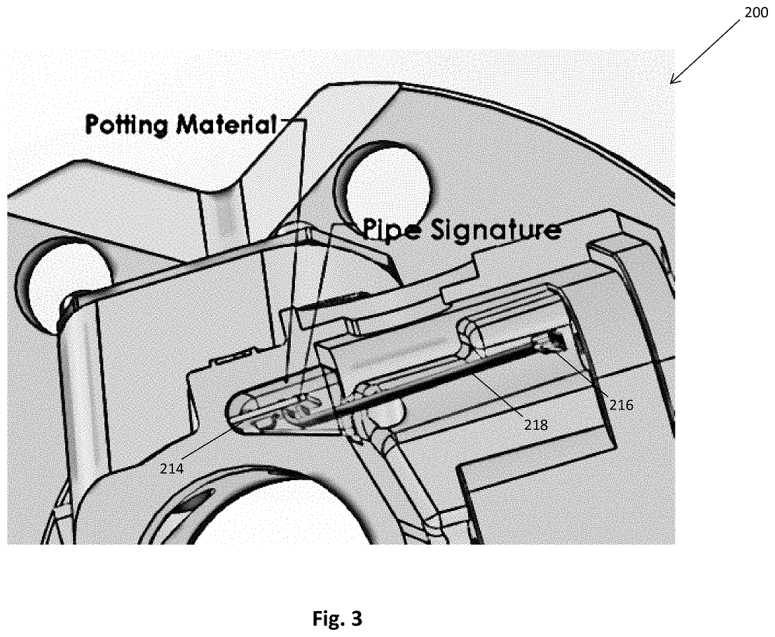

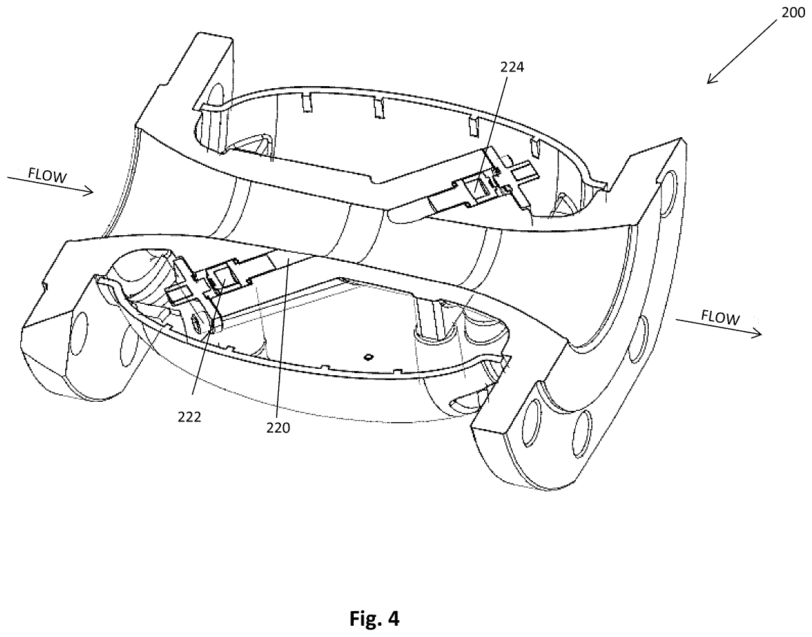

FIG. 4 is an isometric view of the apparatus of FIG. 2A cut-away on a horizontal plane. FIG. 4 shows the fluid flow path extending from an inlet to an outlet defined by the body of apparatus 200. In the implementation illustrated here, apparatus 200 also includes a channels 220 which define an ultrasound transmission path extending across the fluid flow path between a first ultrasonic transducer 222 and a second ultrasonic transducer 224. Each transducer 222, 224 transmits an ultrasonic signal into the fluid within the flow path, which is received by the other transducer 224, 222 after the signal passes through the fluid, allowing determination of a time-of-flight of the signals in both directions. Channels 220 define an ultrasound transmission path which is obliquely angled to the flow direction so that the time-of-flight of the ultrasound signals is affected by a fluid flow velocity within the channel. By determining a difference in the time-of-flight in the two directions, the flow velocity of a fluid flow within the flow path can be determined. Ultrasound flow sensors of this type are well known and widely commercially available, so the details for implementation of the sensor, and the various electronic and/or software components that operate the sensor, will not be described here.

It will be appreciated that the present invention is not limited to this particular implementation of the ultrasound measurement technique, and is equally applicable to any and all ultrasound flowmeter sensing techniques, such as those measuring flow based on Doppler shift, as well as magnetic flowmeters based on inductive effects of a water flow and any and all other flow measurement techniques.

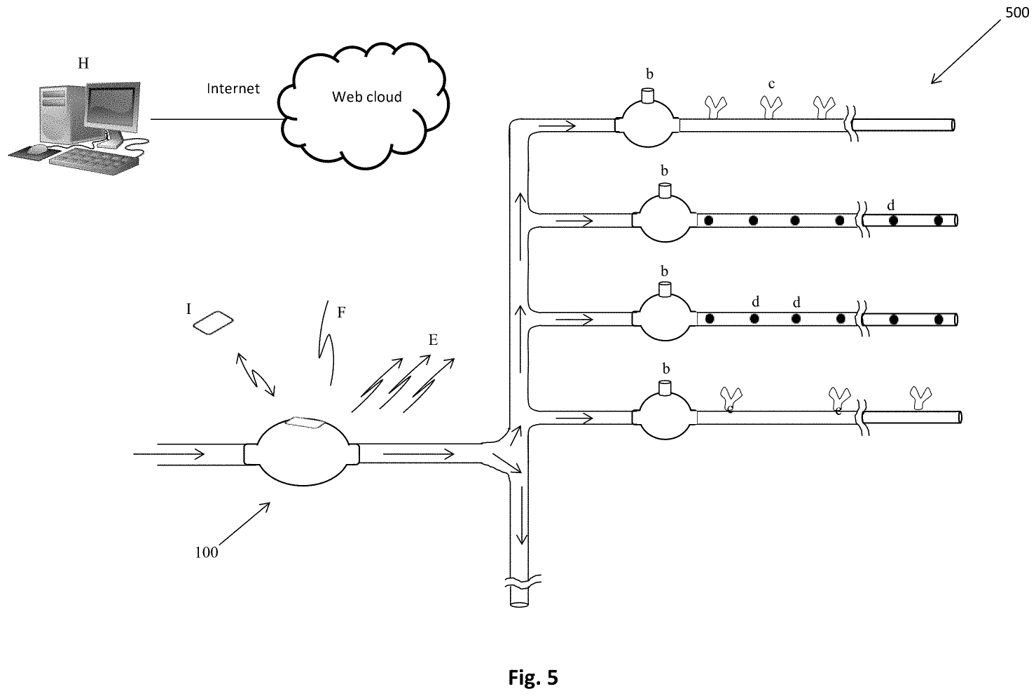

FIG. 5 is a schematic illustration of apparatus 100 integrated as a flow management system for a fluid flow system, such as an irrigation system 500. Apparatus 100 may advantageously be implemented according to the one or more of the features of exemplary implementation 200, as detailed above, as part an irrigation system 500. Irrigation system 500 includes apparatus 100, water valves “b”, sprinklers “c” and drippers “d”. All parts of irrigation system 500 are interconnected with apparatus 100 and to each other using, for example, pipes, tubes and the like, so that apparatus 100 measures the water supplied to the activated components of the system. The wireless communications interface of apparatus 100 is in wireless communication (illustrated by arrows “E”) with at least the water valves “b” to selectively actuate them to switch on (open) and off (close) according to a desired watering program, typically also defined in terms of quantities of water to be delivered via each irrigation subsystem, according to water flow volumes determined by the flowmeter. In some cases, apparatus 100 may be in communication with other sensors which generate output which may be used in adjusting the watering program as in known in the art, such as one or more temperature sensor, moisture sensor etc. (not shown). Apparatus 100 can be remotely controlled using a wireless controller “I”, such as a smartphone or a local PC, and/or via cellular or other wide area network (WAN) connection “F” to a remote server or cloud service which monitors and/or controls operation of the system. By monitoring changes in flow rate in response to valve open/close control signals, apparatus 100 is also able to provide information regarding the condition of the system and different components within the system in a real-time, identifying malfunctions and notifying a local and/or remote controller regarding any issued requiring attention.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An apparatus integrating a flowmeter and a controller for a system including at least one wirelessly controllable flow-control device, the apparatus comprising:
a body defining a fluid flow path from an inlet to an outlet;
a fluid flow sensor mechanically associated with said body and configured to generate a signal sufficient to allow derivation of a rate of fluid flow along said flow path;
a wireless communications interface mechanically associated with said body and configured for communicating with the at least one wirelessly controllable flow-control device; and
a processing system, mechanically associated with said body, comprising at least one processor and a data storage device, said processing system being in communication with said sensor and said wireless communications interface, the processing system being configured to:
derive from said signal a volume of the fluid passing along said flow path; and,
generate control signals to be transmitted by said wireless communications interface for actuation of the at least one wirelessly controllable flow-control device according to a program.

2. The apparatus of claim 1, wherein said fluid flow sensor comprises an ultrasonic transducer configured to transmit an ultrasonic signal into fluid within said flow path; and
an ultrasonic transducer configured for receiving said ultrasonic signal after passing through the fluid.

3. The apparatus of claim 1, further comprising:
at least one electrically controlled valve controlling flow along a flow path supplied via said flowmeter;
at least one additional device selected from the group consisting of: a sensor, a pump and a greenhouse environment controller; and
wireless communications components providing wireless communication between said electrically controlled valve, said at least one additional device and said controller.

4. The apparatus of claim 1, wherein said wireless communications interface uses a form of communication selected from the group consisting of: Bluetooth communication, GPRS communication, cellular communication and the combination thereof.

5. The apparatus of claim 1, wherein said program is defined in part by at least one volume of fluid to be delivered as derived by said processing system.

6. A flowmeter comprising:
a body defining a fluid flow path from an inlet to an outlet;
a fluid flow sensor configured to generate a signal indicative of a rate of fluid flow along said flow path, said fluid flow sensor comprising:
an ultrasonic transducer configured to transmit an ultrasonic signal into fluid within said flow path, and
an ultrasonic transducer configured for receiving said ultrasonic signal after passing through the fluid; and
a processing system comprising at least one processor and a data storage device, said processing system being in communication with said sensor, the processing system being configured to:
derive from said signal a flow rate of the fluid passing along said flow path;
when said flow rate exceeds a threshold flow value, to integrate said flow rate to determine a volume of the fluid that has passed along said flow path; and,
at least when said flow rate is below said threshold flow value, to generate an output indicative of a detected fluid flow along the fluid flow path.

7. The flowmeter of claim 6, further comprising a graphic display screen associated with said body and in communication with said processing system, wherein said output is generated as a visual indication on said graphic display screen of said detected fluid flow.

8. The flowmeter of claim 6, wherein said output is generated as an alert transmitted to a remote location.

9. The flowmeter of claim 6, wherein said processing system is in communication with a wireless controller.

10. The flowmeter of claim 6, wherein said processing system is further configured to identify at least one condition selected from the group consisting of: a faulty flow-control device, a leak, a blockage, and presence of air bubbles.

11. A flowmeter comprising:
a body defining a fluid flow path from an inlet to an outlet;
a fluid flow sensor configured to generate a signal indicative of a rate of fluid flow along said flow path, said fluid flow sensor comprising:
an ultrasonic transducer configured to transmit an ultrasonic signal into fluid within said flow path, and
an ultrasonic transducer configured for receiving said ultrasonic signal after passing through the fluid;
a non-volatile memory chip permanently mechanically integrated with said body, the non-volatile memory chip storing calibration data for the flowmeter; and
a processing system comprising at least one processor and a data storage device, said processing system being in communication with said sensor and said non-volatile memory chip, the processing system being configured to:
read from said non-volatile memory chip said calibration data; and
derive from said signal and said calibration data a volume of the fluid passing along said flow path.
